(19) United States
(12) Patent Application Publication
(10) Pub. No.: US 2009/0154958 A1
(43) Pub. Date: Jun. 18, 2009

(54) EXPOSURE APPARATUS

(75) Inventor: HAN-BANG CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/254,281

(22) Filed: Oct. 20, 2008

(30) Foreign Application Priority Data
Dec. 17, 2007 (CN) 200710203137.7

(51) Int. Cl. G03G 15/04

(52) U.S. Cl. 399/177

(57) ABSTRACT

An exposure apparatus for curing UV curable adhesive applied to an optical module includes a UV light source, a UV blocking member and a conveyer device. The UV light source emits UV light. The UV blocking member forming a UV light-tight region with the UV light source received therein. The conveyer for conveying the optical module through UV light-tight region to cure the UV curable adhesive by exposure to the UV light.

### BACKGROUND

1. Field

The disclosure generally relates to exposure apparatuses, and particularly to an exposure apparatus for use in a lens module manufacturing process.

2. Description of Related Art

Currently, portable electronic devices such as personal digital assistants (PDAs), cellular telephones, and others, with image capture capability are becoming increasingly popular, requiring the deployment of an image capture device in the device.

A typical lens module includes a base, a barrel, a lens assembly, a spacer and an optical element. The optical element can be, for example, a filter. The lens assembly, the spacer and the optical element are sequentially accommodated and fastened within the barrel along an optical axis of the lens module. In use, the lens assembly, the spacer and the optical element are fastened to the barrel via an adhesive agent, such as ultra-violet (UV) curable glue.

The UV curable glue applied to the lens modules is generally cured by UV light. Referring to FIG. 1, a conventional exposed apparatus 2 includes a UV light source 21 and a conveyer belt 22 disposed corresponding to the UV light source 21. The lens modules to be treated are accommodated in a bearing element 23, on the exposure apparatus 2. Particularly, the bearing element 23 with the lens modules is transmitted by the conveyer belt 22 past the UV light source 21. In use, the bearing elements 23 are placed at one end of the conveyer belt 22, and received as treated bearing elements 23 at the other. However, UV emission from the UV light source is unfocused, such that not only the lens modules but also the operator are exposed thereto, presenting the potential for health hazards.

What is needed, therefore, is an exposure apparatus protecting operators from UV light exposure dangers.

### SUMMARY

An exposure apparatus is provided. In an embodiment, the exposure apparatus for curing UV curable adhesive applied to an optical module includes a UV light source, a UV blocking member and a conveyer device. The UV light source emits UV light. The UV blocking member forming a UV light-tight region with the UV light source received therein. The conveyer for conveying the optical module through UV light-tight region to cure the UV curable adhesive by exposure to the UV light.

Advantages and novel features of the present exposure apparatus will become more apparent from the following detailed description of preferred embodiments when taken in conjunction with the accompanying drawings.

### BRIEF DESCRIPTION OF THE DRAWINGS

The components in the drawing are not necessarily drawn to scale, the emphasis instead being placed upon clearly illustrating the principles of the disclosure.

FIG. 1 is an isometric view of a conventional exposure apparatus.

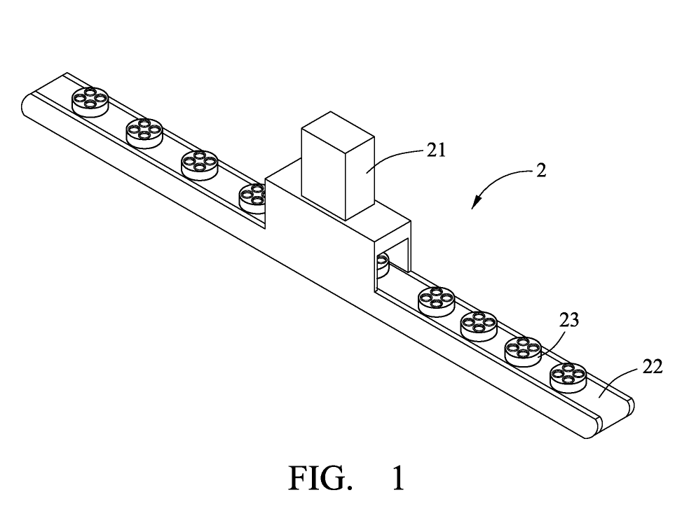

FIG. 2 is an isometric view of an exposure apparatus in accordance with an exemplary embodiment.

Corresponding reference characters indicate corresponding parts. The exemplifications set out herein illustrate at least one preferred or exemplary embodiment of the present exposure apparatus, in various form, and such exemplifications are not to be construed as limiting the scope of the disclosure in any manner.

### DETAILED DESCRIPTION OF THE EMBODIMENT

Reference will now be made to the drawings to describe embodiments of the present exposure apparatus in detail.

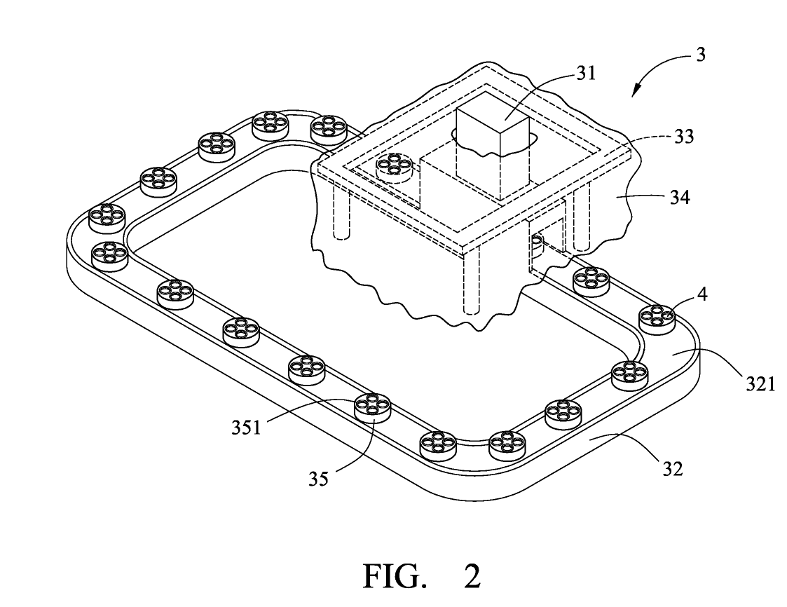

Referring to FIG. 2, an exposure apparatus 3 in accordance with an exemplary embodiment includes a UV light source 31, a conveyer 32, a supporting frame 33, and a UV blocking member 34. In the present embodiment, the exposure apparatus 3 is configured to cure UV curable adhesive applied to an optical module 4.

In the present embodiment, a plurality of optical modules 4 to be treated, e.g. lens modules, is accommodated in a bearing element 35. Particularly, the bearing element 35 includes a plurality of accommodating spaces 351 seating the optical modules 4 to be exposed. The bearing element 35 can be metal, plastic or wood. In the exemplary embodiment, the bearing element 35 is formed as a circular plate, as shown in FIG. 2, and, here, is aluminum and provides four accommodating spaces 351. Alternatively, the accommodating spaces 351 can be any of various other suitable shapes as long as they can retain the optical modules 4 on the bearing element 351.

The UV light source 31 emits UV light providing exposure of the optical module 4. The conveyer 32 is disposed opposite to the UV light source 31. Particularly, the conveyer 32 is disposed so as to enable the optical module 4 to be conveyed through an area of light emission from the UV light source 31. The conveyer 32 includes a conveyer belt 321 configured to bear a plurality of bearing elements 35 seating the optical modules 4. In turn, the lens modules 4 are conveyed via the conveyer belt 321, which can be driven by a motor.

Referring to FIG. 2, the conveyer 32 has a closed conveying route. Particularly, the conveyer belt 321 follows a rectangular path with rounded corners, thereby facilitating exposure of the optical modules 4 by UV light source 31 while conveyed in a closed loop. In the exemplary embodiment, the conveyer belt 321 comprised of metal, rubber, plastic, cloth, or other material. For example, the conveyer belt 321 here is stainless steel.

The supporting frame 33 is disposed around the light source 31 and with the UV light source 31 disposed therein The UV blocking member 34 is disposed over the supporting frame 33 to form a UV light-tight region with the UV light source 31 received therein. That is, the UV blocking member 34 is configured to prevent UV light from indiscriminate emission, limiting emission thereof to a specific area. Operators are protected from harmful UV radiation during operation, accordingly. In the exemplary embodiment, UV blocking member 34 is an UV blocking cloth spread out over the supporting frame 33. In addition, the UV blocking cloth is fastened to the supporting frame 33, for example, by an adhesive. Alternatively, the ultraviolet-impervious cloth can be fastened to the supporting frame by a clip.

In the exemplary embodiment, the supporting frame 33 can be metal, plastic, rubber, or wood. Preferably, the supporting frame 33 is aluminum and rectangular, but is not limited thereto and can be of various other suitable shapes, such as hexagonal or annular, while continuing to support the UV blocking member 34 to cover the UV light source 31.

In use, operators can deploy the bearing elements 35 seating the optical modules 4 on the conveyer belt 321 at a side away from the UV light source 31. In addition, the UV light-tight region is formed by the UV blocking member 34 for receiving the UV light source 31. The bearing elements 35 are then borne by the conveyer belt 321 under the UV light source 31 in succession. Because the operator is isolated from the UV light source 31, by means of the UV light source 31 being covered by the UV blocking member 34 during the operation, there is no hazard from harmful UV light.

Finally, it is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An exposure apparatus for curing UV curable adhesive applied to an optical module, comprising:
a UV light source for emitting UV light;
a UV blocking member forming a UV light-tight region with the UV light source received therein; and
a conveyer for conveying the optical module through UV light-tight region to cure the UV curable adhesive by exposure to the UV light.

2. The exposure apparatus as claimed in claim 1, wherein the conveyer has a closed conveying route.

3. The exposure apparatus as claimed in claim 1, wherein the conveyer includes a conveyer belt comprised of metal, rubber, plastic, or cloth.

4. The exposure apparatus as claimed in claim 1, further comprising a supporting frame with the UV light source disposed therein.

5. The exposure apparatus as claimed in claim 4, wherein the UV blocking member is spread out over the supporting frame.

6. The exposure apparatus as claimed in claim 5, wherein the UV blocking member is a ultraviolet-blocking cloth.
